(19) United States
(12) Patent Application Publication
(10) Pub. No.: US 2026/0328798 A1
(43) Pub. Date: Oct. 22, 2026

(54) WindString: String Anemometers

(71) Applicants: Kendyl A. Roman, Sunnyvale, CA (US); John Livacich, Los Gatos, CA (US)

(72) Inventors: Kendyl A. Roman, Sunnyvale, CA (US); John Livacich, Los Gatos, CA (US)

(73) Assignee: Evrio, Inc., Sunnyvale, CA (US)

(21) Appl. No.: 18/674,864

(22) Filed: May 26, 2024

(51) Int. Cl. G01P 5/02

(52) U.S. Cl. CPC G01P 5/02

(57) ABSTRACT

A novel string anemometer. In some embodiments the string anemometer comprises a string and a scale. Analog embodiments comprise a flexible rod attached to a scale. Embodiments of scales include scale indicators at predetermined intervals. An artificial intelligence (AI) device receives information from the string anemometer and determines the effect of wind along the full path of the string. An embodiment of the AI device receives wind information from a digital scale. Another embodiment of the AI device receives wind information by observing the flex of the flexible rod.

### CROSS-REFERENCE TO RELATED APPLICATIONS

This application is a continuation-in-part of co-pending U.S. patent application Ser. No. 18/431,980, filed Feb. 4, 2024.

### PRIOR ART

### Firing Device and Projectiles

Firing devices such as bows, crossbows, rifles, pistols, other guns, and artillery have been used for sport, hunting, law enforcement, and military. Each firing device is used to launch a projectile such as an arrow, dart, bullet, ball, or explosive shell along a projectile trajectory.

FIG. 1A shows a user (in this case, an archer) 100 with a bow 102 with a bow sight 110 and an arrow 104. The bow sight 110 comprises pins adjusted e.g., for twenty yards, forty yards, and sixty yards, namely a twenty-yard pin, a forty-yard pin, and a sixty-yard pin, respectively.

FIG. 1B shows a rifle with a rifle scope 302. Rifle balls and/or bullets are typically shot from a gun using the arms to aim and sight by aligning the gun sights or gun scope reticle with the target. Artillery balls and shells are typically shot by adjusting the aim mechanically.

Arrows, spears, balls, bullets, and shells when fired follow a ballistic trajectory. Such projectiles, which are not self-propelled, move through air according to a generally parabolic curve due primarily to the effects of gravity.

The actual projectile trajectory path is not a perfect parabola in a plane due to many factors, such as air drag and lift, crosswind, head wind, tail wind, spin drift, and Coriolis effect. Each bullet type has a different weight and shape which affects the ballistic trajectory. Ballistic coefficients can be determined of each bullet. Drag is affected by environmental factors such as temperature, humidity, and barometric pressure.

The Army Research Laboratory published Wind Drift of Projectiles: A Ballistics Tutorial, ARL-TR-1124, by Herbert A. Leupold, October 1996.

Let's Code Physics, Projectile Motion 12-Drag and Wind teaches programming models for drag and wind on projectiles. Source code is available at the letscodephysics Google Site (Let's Code Physics/projectile motion/12 3D projectile motion—football field goal—w wind.py).

Rifle and bow scopes conventionally have been fitted with reticles of different forms. Some have horizontal and vertical crosshairs. These reticles are fixed in that the display does not change based on range information. Also, these reticles indicate the approximate hold-over position in that they are positioned under the center of the scope, i.e., below where the crosshairs intersect. They are not necessarily precise, for example, for a specific bow and archer or for a specific rifle and cartridge but are approximation for the general case.

### Smart Devices

Hunters and other firearm and bow users commonly utilize handheld rangefinders (see device 6 in FIG. 1) to determine ranges to targets. Generally, handheld rangefinders utilize lasers to acquire ranges for display to a user. Utilizing the displayed ranges, the user makes sighting corrections to facilitate accurate shooting. Handheld rangefinders, telescope sights, and other optical devices typically comprise a laser range sensor and an inclinometer.

Our U.S. Pat. No. 9,057,587, issued Jun. 16, 2015, and U.S. Pat. No. 9,068,795, issued Jun. 30, 2015, both included by reference, disclose and claim a smart rangefinders which: a) provide an aiming point; b) provide a digital rangefinder having a video camera and high-resolution digital display; and c) displays an aiming point, corrected for range and wind effect anywhere on the high-resolution display.

These patents also disclose the use of a smart phone, such as an iPhone, as a display for a digital rangefinder.

### Artificial Intelligence Advances

The U.S. Defense Advanced Research Projects Agency (DARPA) funded the Cognitive Assistant that Learns and Organizes (CALO) project for five years from 2003 to 2008. CALO brought together over 300 researchers from 25 of the top university and commercial research institutions. Software and documentation are available on the PAL website: https://pal.sri.com.

Several AI technologies have spun off from the CALO work, including, for example, Apple's Siri speech recognition, analysis, and speech synthesis.

In October 2006, Intel released version 2 of Open Source Computer Vision Library (OpenCV 2). In August 2012, opencv.org began providing support for OpenCV. Applications for OpenCV include object detection and facial recognition systems. Open source code repositories are available on github.com e.g., opencv/opencv.

In 2013, NVIDIA introduced the Tegra 4. With NVIDIA GPU-accelerated deep learning frameworks, researchers and data scientists can significantly speed up deep learning training that could otherwise take days and weeks to just hours and days. When models are ready for deployment, developers can rely on GPU-accelerated inference platforms for the cloud, embedded device, or self-driving cars, to deliver high-performance, low-latency inference for the most computationally-intensive deep neural networks. https://www.nvidia.com/en-us/glossary/deep-learning/.

In June 2014, Facebook AI Research in Menlo Park, CA, published DeepFace: Closing the Gap to Human-Level Performance in Face Verification. DeepFace discloses the use of a four-stage pipeline, comprising: detect, align, represent, and classify. In its deep learning model, the representation stage uses a nine-layer deep neural network. The paper discloses an architecture comprising a front-end of a single convolution-pooling-convolution filtering on the rectified input, followed by three locally-connected layers and two fully-connected layers.

Images are aligned by detecting 6 initial fiducial points inside the detection crop (bounding rectangle) centered at the center of the eyes, tip of the nose and mouth locations. The detected face is scaled, rotated, and translated. Additional fiducial points are identified in the 2D-aligned crop. The image is 3D aligned by transforming Delaunay triangulation derived from the 67 fiducial points. The 3D-aligned image is given to the first layer of a large deep neural network.

As explained by Sefik Ilkin Serengil, the DeepFace deep learning model is a layered convolutional neural network. Each layer is named with a letter and number. The number refers to the index from 1 to 8 and letter states the type of layer. C refers to convolutional layer, M refers to max pooling, L refers to locally connected layer and F refers to fully connected layer. https://sefiks.com/2020/02/17/face-recognition-with-facebook-deepface-in-keras

OpenFace is open source code. https://github.com/cmusatyalab/openface

OpenFace includes the FaceBook neural network source code. https://github.com/facebookarchive/fbnn

In December 2014, Baidu Research's Silicon Valley AI Lab, published Deep Speech: Scaling up end-to-end speech recognition. Deep Speech trained a large recurrent neural network (RNN) using multiple GPUs and thousands of hours of data. The structure of the RNN model is disclosed in the paper.

Cornell University's Cornell Lab of Ornithology, Merlin project was funded by the Natural Science Foundation. Photo ID, released Nov. 30, 2017, uses computer vision technology, developed as part of Dr. Grant Van Horn's doctoral work at Caltech, to identify birds in photos. Sound ID, released Jun. 23, 2021, learned to recognize the vocalizations of different bird species. Sound ID was trained on audio recordings that are first converted to visual representations (spectrograms), then analyzed using computer vision tools similar to those of Photo ID. Both Photo ID and Sound ID run on smart phones, such as the Apple iphone. https://merlin.allaboutbirds.org

Grant Van Horn's PhD thesis is entitled Towards a Visipedia: Combining Computer Vision and Communities of Experts, and details recent advances in the use of deep convolutional neural networks in image analysis.

U.S. Pat. No. 11,140,312 was filed by Swarovski-Optik Jul. 17, 2020 (Swarovski '312). U.S. Patent Application 2023/0283882 published Sep. 7, 2023 (Swarovski '882). Both disclose a smart binocular.

FIG. 2 shows binocular 400 comprising a housing 20 supporting an eyepiece 22, a lens 24, an input, an operating button, 32. The components inside the housing 20 comprise: computing element 16, memory 18, wireless communications 19, image sensor (digital camera) 25, audio sensor 29. Swarovski claims require several other elements. Swarovski discloses using the wireless communications 19 to communicate with a smart phone, such as an iPhone 11 (not shown) having a high-resolution, touch screen display 31 (not shown). While Swarovski '312 suggests that the smart phone 11 separately execute a mobile app which can recognize an image of a bird, it does not disclose a deep learning model running on the computing element 16 of the binocular 400. The type of bird is recognized by means of a remote image database and an image recognition algorithm. Further, Swarovski '312 discloses using the operating button 32 to start the image capture for object recognition, object detection, and object classification to be executed on the smart phone 11.

In January 2024, Swarovski Optik announced smart binoculars, namely, AX Visio 10×32 binoculars, comprising a neural processing unit (NPU) for object recognition processing, which identifies over 9,000 species of birds and mammals using Merlin Photo ID and Sound ID image recognition technology.

In January 2024, Apple unveiled chips having capabilities to run generative AI, for example, supporting billions of data parameters. The S9 chip allows Siri to access and log data without connecting to the Internet. The A17 Pro chip in the iPhone 15 comprises a neural engine which is twice as fast as previous generations. These advances will allow AI models to run directly on iPhones.

Thus, the deep learning models for recognizing and characterizing audio and images, as well as source code for implementing them, GPU systems for learning, and handheld devices for operating those deep learning models are well known in the art.

### Windage and Elevation

For hundreds of years, hunters and soldiers have learned the mantra “Windage and Elevation.”

However, there has been a long felt need to be able to accurately recognize the winds impact on a projectile and to quickly and dynamically make adjustments despite constant changing and difficult to interpret changes in the wind. Wind adjustment has been largely guesswork.

Until now accurate wind recognition has been the “Holy Grail” sought after by the industry.

What is needed is a device and methods for recognizing wind along a projectile trajectory path so that a user can accurately aim and hit a desired target regardless of the wind speed and direction at different points along the path. Further, what is needed is an indication that wind currently is in a likely sustained favorable state for a brief period of time, such that a user has time to aim and fire.

The parent application discuses the need for accurate wind recognition.

Our patented Flight Path® technology (disclosed, for example, in U.S. Pat. No. 9,057,587 referenced above) currently available in Leupold RX-FullDraw 5 and RX-1400i True Ballistic Range/Wind (TBR/W) Gen 2, does an excellent job of handling elevation by providing an aiming point corrected for shoot angle, distance, and ballistics.

There has been a long felt need to be able to accurately recognize the impact of wind along the projectile trajectory path, not in just at the point of fire or at a few finite points along the path.

What is needed is a device and methods for recognizing wind effect on a projectile trajectory and to provide an indication that there is a steady state of wind at a known value.

### BACKGROUND OF THE INVENTION

The parent invention relates to detection of wind, in particular the detection of wind that affects a projectile trajectory path to a desired target, including the use of artificial intelligence (AI) to observe a string supported by flexible rods, positioned along a segment of the projectile trajectory path, and to recognize the wind effect on the object, such as the rod and/or string.

The present invention relates string anemometers. An analog string anemometer comprises a string and analog gauge comprising a flexible rod and a scale attached to a base. A digital string anemometer comprises a string attached to a digital scale.

The AI is embedded in an AI device having an image sensor and optional laser rangefinder for training the AI. The present invention also relates to devices which an detect wind effect along the full path of the string by observing the analog string anemometer or by observing the trends reported by a digital string anemometer.

### SUMMARY OF THE INVENTION

The present invention solves the above-described problems and provides a distinct advance in the art of AI devices for recognizing wind along a full path of a string anemometer.

The AI device further comprises a computing element, a memory, a display, at least one image sensor. The AI device captures a magnified digital image of an analog string anemometer, or receives data from the a digital string anemometer. The deep learning model operates on the computing element and memory and determines the wind along the full path to a target.

In some embodiments, the computing element determines a bounding rectangle in the digital image which includes the string anemometer, and crops the digital image based on the bounding rectangle.

In some embodiments, the computing element determines a plurality of fiducial points inside the bounding rectangle.

In some embodiments, the computing element performs a 2D or 3D alignment of the string anemometer based on the fiducial points.

In one embodiment, the AI device further comprises wireless communication to communicate wirelessly with remote sensors, such as digital string anemometers) or other atmospheric meters, or with a handheld rangefinder, smart scope, smart binocular, or other device.

The deep learning model comprises a deep neural network.

In some embodiments, the deep neural network is a convolutional neural network.

In some embodiments, a cropped image or a cropped aligned image is an input to the deep learning model.

During training, inputs to the deep learning model comprise a cropped image of the string anemometer and the surround objects such as trees, shrubs, and grasses. Training data may also include wind information from at least one point along the path, GPS location and elevation, and atmospheric data, such as humidity and pressure.

During operation, in some embodiments, the AI device recognizes the string anemometer and determines the crosswind effect on the full path of the string.

A method embodiment of using the AI device comprises the steps of:
a) training the deep learning model with a multiplicity of images,
b) aiming the AI device at the target by placing the crosshairs over the target,
c) pressing an operating button on the AI device, and
d) displaying a cross wind the display.

A string anemometer comprises, a string and a scale, wherein the string detects the effect of wind along a full path of the string. Preferably the string is deployed between 40 yards and 1000 yards.

Embodiments with an analog scale comprise a flexible rod and a means to visualize the flex of the rod.

In a preferred embodiment for a long-range shooting the flexible rod is a half inch fiberglass rod, and the string is configured to be between 100 and 1,000 yards. A pulley mounted to a post or a tree allows the flex of the rod, as well as the full path of the string to the target, to be visualized by the user or an AI device.

In another preferred embodiment for archery or slower projectiles, or for capturing wind training data with images of plants such as trees, shrubs, and grasses, the flexible rod is attached to a gauge base having a scale panel with tick marks; or vanes or rods providing scale indicators; positioned at predetermined intervals. In some embodiments, the gauge base and a pulley are mounted on a tube (preferably square aluminum tube) so that the user or AI device can observe the shape and position of the string as well as the dynamic flex of the gauge rod.

In some embodiments, the gauge can be disassembled, and the scale indicator rods or vanes stowed inside the tube for transport to the field.

In some embodiments, the scale base further comprises a scale slot which accepts different types of scale indicator configurations, including a 50 degree scale, a 90-degree scale, a plurality of fan vanes, or a plurality of single vanes.

In some embodiments, a tip connector is permanently attached to the flexible rod, the tip connector having a hole for attaching the string to the flexible rod.

In some embodiments, the scale base is removably attached to the tube with a metal bolt, preferably with a wing-nut for easy removal in the field, and a plastic pin.

In some embodiments, the scale is a digital scale with a display. The digital string anemometer communicates the scale value wirelessly, such as a Bluetooth wireless connection.

In a system comprising the string anemometer and an AI device, the digital scale communicates the digital scale value to the AI device, the AI device determines a steady state of the wind, and the AI device displays a cross wind speed. The system displays red, yellow, and green indicators to show when the window value is in a steady state. For example, the AI device can determine a current wind value and illuminate a yellow LED when steady wind is approaching, and a green LED steady wind state is achieved. This allows a shooter to adjust their aim based on the predicted steady state wind value and to fire the projectile the shooter sees the green light.

In a system comprising an analog string anemometer and an AI device, the AI device observes the flex of the rod, and the shape and position of the string along the full path of the string, determines a steady state of the wind, and displays a cross-wind speed.

Other aspects and advantages of the present invention will be apparent from the following detailed description of the preferred embodiments and the accompanying drawing FIGURES.

### Objects and Advantages

Accordingly, the present invention provides the following objects and advantages:

To provide a display that provides dynamic information regarding a projectile trajectory.

To provide a lightweight rangefinder comprising a high-resolution display and a digital camera, wherein the display provides an aiming point adjusted for wind and distance.

To provide an AI device, having a deep learning model, which is trained to recognize wind effect along the full path to a target.

### BRIEF DESCRIPTION OF DRAWINGS

A preferred embodiment of the present invention is described in detail below with reference to the attached drawing FIGURES, wherein:

FIG. 1A illustrates an archer with a bow with a bow sight;

FIG. 1B illustrates a rifle with a scope;

FIG. 2 illustrates a smart binocular with a digital camera image sensor;

FIG. 3 is a block diagram of an AI device;

FIG. 4 illustrates the AI device in a housing and an operating button input;

FIG. 5 illustrates the training of the AI device string anemometer, wherein a string is supported by a rod and attached to a far string anchor;

FIG. 6 illustrates the string being supported at an intermediate point by a hook lifted over a tree branch by a cord, the string following a projectile trajectory path;

FIG. 7 illustrates a flexible rod, preferable marked with dark and light bands;

FIG. 8 illustrates a string and a flexible rod placed in a harsh, rough environment with hills and valleys and strong winds at different speeds and directions along the projectile trajectory path;

FIG. 9 illustrates crosswind and tailwind vector elements of wind;

FIGS. 10A through 10F illustrate the use and operation of the AI device:

FIG. 10A illustrates the AI device with a rod and a string positioned along a projectile trajectory path to a target, the string passing through a pulley,

FIG. 10B illustrates an image captured by the AI device showing string shape and position and the flex of the rod,

FIG. 10C illustrates a detection crop of the image with four bounding points forming a bounding rectangle containing the cropped image of the string and rod,

FIG. 10D illustrates fiducial points found on the string and rod,

FIG. 10E illustrates fiducial points defining the shape and position of the string,

FIG. 10F illustrates fiducial points defining the flex of the flexible rod;

FIG. 11 shows an analog string anemometer comprising a string, a flexible rod, a pulley, a scale attached to a base.

FIG. 12 shows an embodiment of an analog string further comprising a handle and string notches for winding up the string.

FIG. 13 shows another embodiment of an analog string anemometer comprising a string, a flexible rod, a pulley, a scale comprising scale rods attached to a base which is further bolted and pinned to a square tube having the pulley attached at the other end, where the string is attached to the flexible rod with a tip connector;

FIG. 14 illustrates features of a scale base having a scale slot;

FIG. 15 illustrates a tip connector;

FIG. 16 illustrates a pin for removable attaching a scale base to a tube;

FIGS. 17A through 17E illustrate embodiments of scales or scale vanes;

FIG. 18 illustrates a digital string anemometer.

FIG. 19 illustrates a display with indication of the crosswind speed and indicators of a steady state of optimum wind;

FIG. 20 is a chart showing what would be displayed on the display of FIG. 19 based on charted, exemplary crosswind values over a five minute period.

The drawing FIGURES do not limit the present invention to the specific embodiments disclosed and described herein. The drawings are not necessarily to scale, emphasis instead being placed upon clearly illustrating the principles of the invention.

REFERENCE NUMERALS IN DRAWINGS

| | | |
|---|---|---|
| 6 | | rangefinder |
| 10 | | AI device |
| 11 | | iPhone |
| 16 | | computing element |
| 18 | | memory |
| 19 | | wireless communications |
| 20 | | housing |
| 25 | | image sensor (digital camera) |
| 29 | | audio sensor |
| 30 | | display |
| 31 | | high-resolution display |
| 32 | | inputs |
| 36 | | image |
| 37 | a-d | bounding point |
| 38 | a-i | fiducial point |
| 40 | a-c | string |
| 48 | | wind |
| 52 | | crosswind vector |
| 56 | | tailwind vector |
| 100 | | archer or user |
| 102 | | bow |
| 104 | | arrow |
| 106 | | flexible rod |
| 108 | | string anchor |
| 110 | | bow sight |
| 300 | | rifle |
| 302 | | scope |
| 510 | | pulley |
| 512 | | pulley attachment |
| 514 | | square tube |
| 520 | | gauge rod, attached flexible rod |
| 522 | | tip connector |
| 530 | | scale base |
| 532 | | rod hole |
| 534 | a-f | scale rod |
| 534 | | scale slot |
| 536 | | vane pivot |
| 537 | | pin hole |
| 538 | | bolt hole |
| 540 | | scale |
| 542 | | gauge handle |
| 544 | a, b | string notch |
| 550 | | 50 degree scale |
| 560 | | scale vane |
| 562 | a-c | fan vane |
| 564 | a-e | single vane |
| 566 | | vane spacer |
| 568 | a-c | ribbon hole |
| 570 | | pin |
| 580 | | bolt |
| 582 | | wind nut |
| 590 | | 90 degree scale |
| 610 | | digital scale |
| 612 | | scale display |
| 614 | | scale wireless communication |
| 710 | | branch |
| 712 | | hook |
| 922 | | crosswind indicator |
| 924 | | green indicator |
| 926 | | yellow indicator |
| 928 | | red indicator |

### DETAILED DESCRIPTION OF THE INVENTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the present invention. The following detailed description is, therefore, not to be taken in a limiting sense. The scope of the present invention is defined only by the appended claims, along with the full scope of equivalents to which such claims are entitled.

### The String

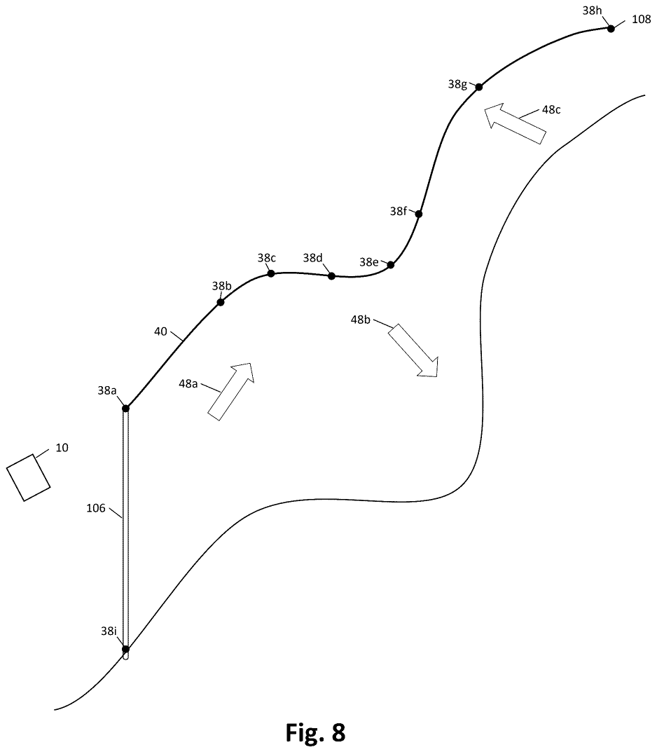

Over a decade ago we performed an experiment with a 270-yard string 40 supported by a flexible rod 106 in a harsh, rough environment with hills and valleys and strong winds at different speeds and directions along the projectile trajectory path to a target T (see FIG. 8). We discovered that the “string is the teacher.” By observing the effects of the combined winds on the string, including both the sounds and the visual image of the string and the flexible rod, human users could determine a period of consistent wind, adjust their aim for that wind, and repeatedly hit the target using that aiming point each time the users sensed the presence of the optimum steady wind conditions. The sound of the wind was easier to distinguish at higher wind speeds. In our experiment, the string taught us how to adjust our aim and when we could repeat a shot under the same and highly similar instantaneous wind conditions. The bullets consistently hit a desired target at 270 yards in strong dynamic wind conditions.

In our experiment, we used a 600-yard spool of 80-pound test Izorline braided low stretch Dacron fishing line, UPC 8783700307. The string was white with “greenspot” spiral markings. The rod was solid ½ inch fiberglass rod.

We discovered that the string is the teacher. What was needed were low cost, light weight, portable platforms with high quality optics, digital camera, and computing capabilities so that we could implement a machine learning solution which could also be taught by the string and could instantaneously observe current wind effects and provide crosswind, headwind/tailwind, information; could determine a presence of a stable optimum wind, and an adjusted aiming point. With advances in AI technology and platforms that can be made available to general users, we can now implement our invention as devices and methods for recognizing wind along a projectile trajectory path so that a user can accurately aim and hit a desired target regardless of the wind speed and direction at different points along the path, and provide an indication that wind currently is in a likely sustained favorable state for a brief period of time, such that a user has time to aim and fire.

More recently, we have experimented with supporting the string with flexible rods with equal height, e.g., 5-foot rods, preferably with 6-inch bands of darker color and/or reflective materials. We have experimented with different strings and have had good results with green mono filament line. To aid in recognizing the wind, by observing the string, it is useful to know the amount of string. An AI device can recognize the distance of an object of a known size, such as the flexible rod, animal, bird, or vehicle, by analyzing its visually apparent size in the image at a known magnification. See our co-pending DeepRange application.

Accordingly, we disclose details of string anemometers. A system comprising an AI device and aa string anemometer recognizes the wind effect on the full path of the string and provides an indication of wind speed at a steady state.

### AI Device

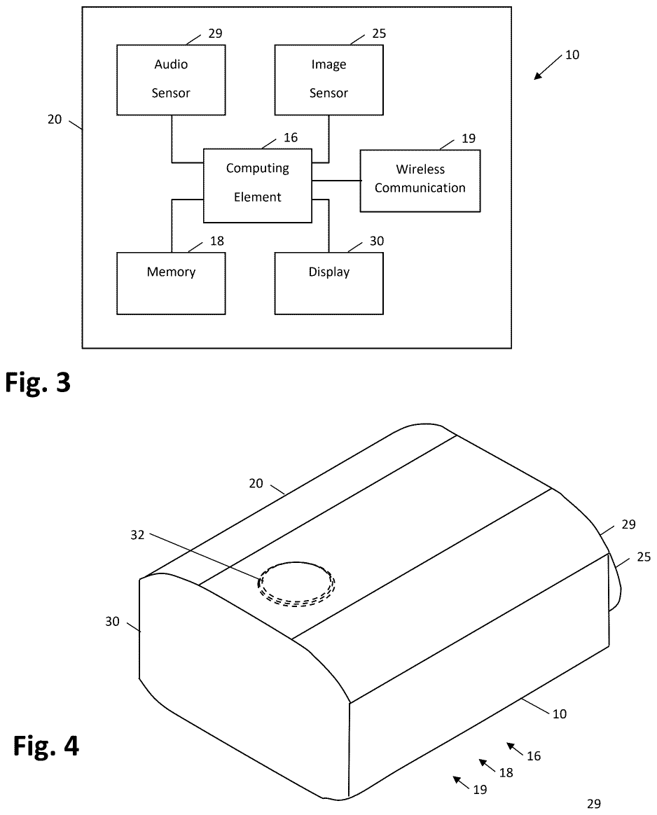

FIG. 3 illustrates our novel AI device 10 comprising a computing element 16, coupled with an audio sensor 12 or an image sensor 14, a display 30. A housing 20 contains the elements of the device 10.

FIG. 4 shows our novel AI device 10 comprising a housing 20 supporting a display 30, an operating button input 32. The components inside the housing 20 comprise: computing element 16, memory 18, wireless communications 19, image sensor (digital camera) 25, audio sensor 29. One or both of the image sensor 25 and the audio sensor 29 is configured in different embodiments.

The display 30 could be a high-resolution, touch screen display 31.

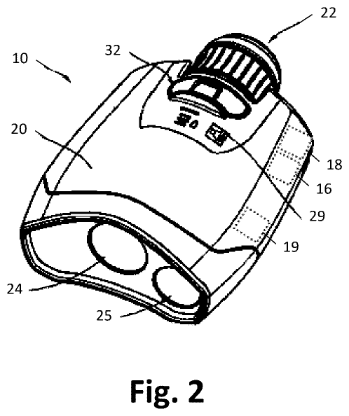

Comparing FIG. 4 to FIG. 2 results in understanding that while Swarovski binocular is an enabling platform for our present invention, it contains elements which are not required by our present invention. In other words, the reader should understand that the present invention could be implemented entirely on a Swarovski binocular or similar device but could also be implemented as disclosed herein without requiring the invention claimed by Swarovski. Further, Swarovski only clearly discloses identification of birds and mountain peaks. It is silent on determining range, on recognizing wind, or on projectile trajectory paths.

The handheld housing 20 enables AI device 10 to be easily and safely transported and maneuvered for convenient use in a variety of locations.

For example, the portable handheld housing 20 may be easily transported in a backpack for use in the field. Additionally, the location of the components on or within the housing 20 and the location of the button 32, enables AI device 10 to be easily and quickly operated by the user with one hand without a great expenditure of time or effort.

A computer program preferably controls input and operation of the AI device 10. The computer program includes at least one code segment stored in or on a computer-readable medium residing on or accessible by AI device 10 for instructing computing element 16, image sensor 25, audio sensor 29, and any other related components to operate in the manner described herein. The computer program is preferably stored within the memory 18 and comprises an ordered listing of executable instructions for implementing logical functions in AI device 10. However, the computer program may comprise programs and methods for implementing functions in the device 10 which are not an ordered listing, such as hard-wired electronic components, programmable logic such as field-programmable gate arrays (FPGAs), application specific integrated circuits, conventional methods for controlling the operation of electrical or other computing devices, etc.

Similarly, the computer program may be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

AI device 10 and computer programs described herein are merely examples of a device and programs that may be used to implement the present invention and may be replaced with other devices and programs without departing from the scope of the present invention.

The computing element 16 is coupled with image sensor 25, audio sensor 29, wireless communication 19, 9-axis sensor 15 (not shown) to determine the effect of wind on the full path of a string, as is discussed herein. The computing element 16 may be a microprocessor, microcontroller, or other electrical element or combination of elements, such as a single integrated circuit housed in a single package, multiple integrated circuits housed in single or multiple packages, or any other combination. Similarly, the computing element 16 may be any element that is operable to determine clear shot information from the range and angle information as well as other information as described herein. Thus, the computing element 16 is not limited to conventional microprocessor or microcontroller elements and may include any element that is operable to perform the functions described.

The memory 18 is coupled with the computing element 16 and is operable to store the computer program and a database including trained representation and classification for comparison, and configuration information. The memory 18 may be, for example, an electronic, magnetic, optical, electromagnetic, infrared, or semi-conductor system, apparatus, device, or propagation medium.

The device 10 also preferably includes a display 30 to indicate relevant information such as the crosshairs 900, distance indicator 910, and other indicators disclosed herein. The display 30 may be a conventional electronic display, such as an OLED, TLED LED, TFT, or LCD display, or a higher resolution pixel matrix, e.g., with a resolution of 304×256.

The inputs 32 are coupled with the computing element 16 to enable users or other devices to share information with AI device 10. The inputs 32 are preferably positioned on the housing 20 to enable the user to simultaneously view the display 30 and function the inputs 32.

The inputs 32 preferably comprise one or more functional inputs such as buttons, switches, scroll wheels, etc., a touch screen associated with the display 30, voice recognition elements, pointing devices such as mice, touchpads, trackballs, styluses, combinations thereof, etc. Further, the inputs 32 may comprise wired or wireless data transfer elements.

### Training

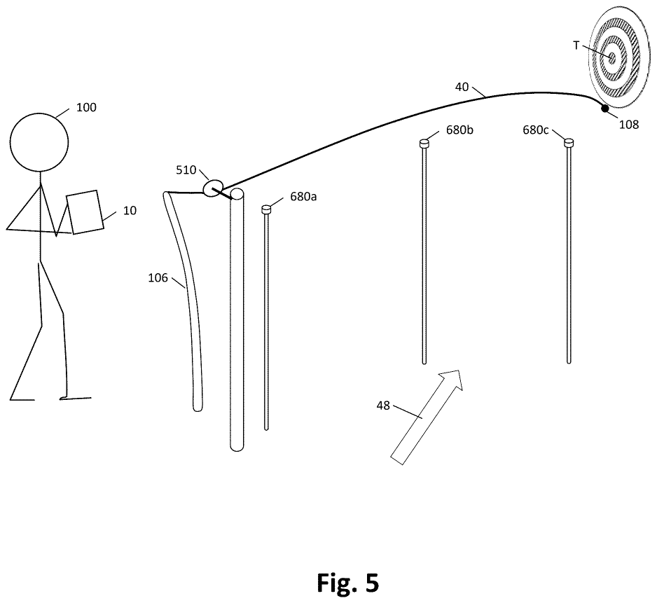

FIG. 5 illustrates the training of the AI device 10 with a string 40 and wind sensors 680a through 680c, positioned along a projectile trajectory path to a target T.

The user 100 is shown with the AI device 10. In this embodiment, the string 40 is supported a flexible rod 106, and is attached at the far end to a string anchor 108. The rod 106 holds the string 40 off the ground in the wind 48 along at least a segment of the projectile trajectory path. In other embodiments for wind detection, the string could be attached to two fixed points one at each end.

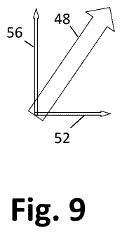

The string 40 shows that the wind 48 has both a tailwind and left moving cross wind (see FIG. 9). The tailwind is evidenced by the curve of the string 40 toward the target T. The left moving crosswind is evidenced by the curve of the string 40 toward the left of the line of sight to the target, and to the left of the rod 106 and string anchor 108.

The AI device 10 is positioned where it can sense the string 40 and the rod 106. In some embodiments, the AI device 10 senses the sound made by the wind 48 as it moves and passes over the string 40. In some embodiments, the AI device 10 senses the image made by the wind 48 as it dynamically moves the string 40 and flexes the rod 106. In other embodiments it senses both sound, with the audio sensor 29 (FIG. 3 and FIG. 4), and photos or videos, with the image sensor 25 (FIG. 3 and FIG. 4).

A plurality of conventional wind meters 680 (also known as anemometers) are shown positioned along path of the string 40.

Wind meters are well known in the art, such as Kestrel 1000 wind meter or the Kestrel 3550FW fire weather meter. Wind meters are known to provide wind direction and speed via wireless communications.

The parent application introduces a new class of anemometer, namely, a string anemometer which senses the wind along the full path of the string, not just a few finite points along the path.

Our U.S. Pat. No. 8,795,109, issued Aug. 5, 2014, and U.S. Pat. No. 9,482,505, issued Nov. 1, 2016, both included by reference, disclose and claim a wind tracking apparatus which can be deployed by shooting an arrow comprising a wind meter or wind sensor 680 on nock end of the arrow, which then wirelessly transmits wind speed and direction. One wind meter or sensor was disclosed as an ultrasonic anemometer.

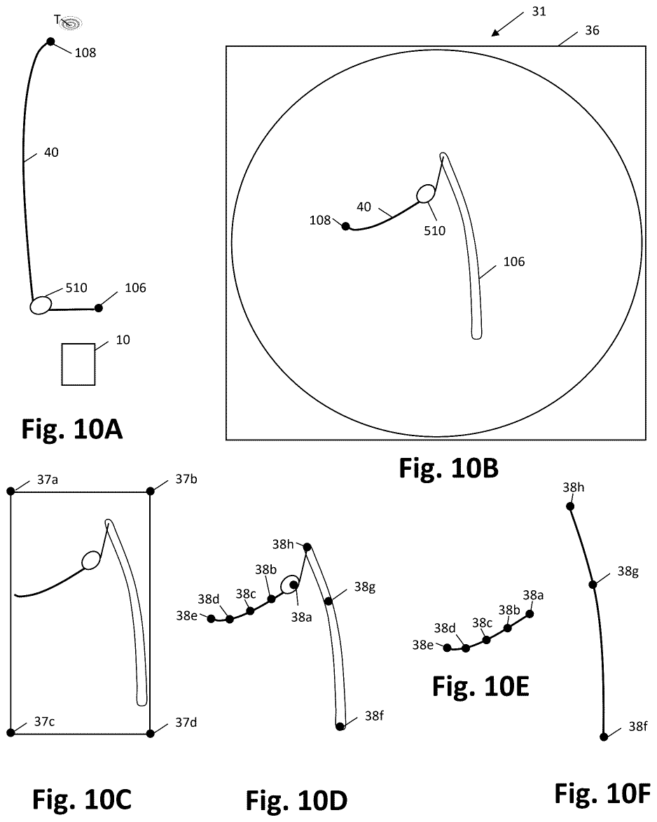

A large multiplicity of images 36 (FIG. 10B) and/or audio are captured by an embodiment of the AI device 10, such binocular AI device 10 of FIG. 2, or other conventional recording means such as cameras, audio records, or smart phones 11, such as iPhones. The multiplicity of images 36 (FIG. 10B) and/or audio are capture while observing the string 40 during thousands of different wind conditions. With each image or audio capture, the wind information from the plurality of wind meters 680 are received wirelessly and stored in a dataset along with each image or audio recording. The dataset is used as input to train the deep learning model of the AI device 10.

### Projectile Trajectory Path

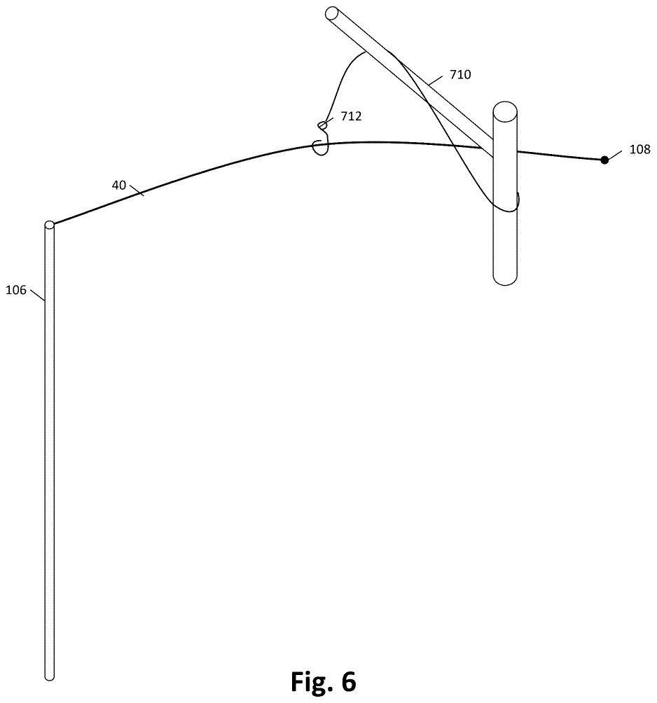

Preferably, the length of the string 40 can be up to 1000 yard. With that distance, it is difficult to keep the string off the ground. FIG. 6 shows a novel solution where the string 40 is suspended by a hook 712 which is lifted by a cord which has been thrown over a tree branch 710 and tied off to the tree. This allows for the string to held closer to the actually projectile trajectory and held off the ground. Depending on the terrain a plurality of hooks may be needed at different points.

### Flexible Rods and Extensions

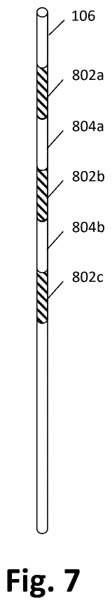

It is advantageous to have rods 106 of different lengths. FIG. 7 illustrates a flexible rod 106, preferable marked with dark bands 802 and light bands 804. Dark bands 802a, 802b, and 802c are preferably 6-inches long and are separated by 6-inch long light bands 804a and 804b. In this preferred embodiment the rod is 5 feet long, and the top 3 feet are easily identified at the bottom of each dark band 802, namely, 1 foot at the bottom of 802a, 2 feet at the bottom of 802b, and 3 feet at the bottom of 802c.

The dark bands 802 and light bands 804 of a predetermined length aid the AI device is detecting the location and flex of the rod 106. Further, the AI device determines the distance from the AI device to rod 106 and determines length of the string based on the distance between the rod 106 and the end of the string, or target. While not required, the dark bands 802 and light bands 804 enhance the captured images 36 and improve the rod 106 and string 40 recognition, detection, and alignment.

### Complex Harsh Natural Environments

FIG. 8 illustrates a string 40 attached flexible rod 106 and string anchor 108 placed in a harsh, rough environment with hills and valleys and strong winds at different speeds and directions along the projectile trajectory path. The terrain causes different wind represented by wind 48a, 48b, and 48c. Wind 48a is illustrated going up the near hill toward the target T. Wind 48b is shown as an opposing cross wind moving right along the valley and adjacent cliff. Wind 48c is shown with a right crosswind and a slight headwind from wind coming over the taller mount crest.

The reader will see that the fiducial points 38a through 38h is a more complex curve. Such a curve may be too difficult for a human to interpret in a short enough time to make an ethical shot. However, the present invention provides the possibility of rapid accurate analysis faster than a human.

### Crosswind and Tailwind Vectors

FIG. 9 illustrates crosswind and tailwind vector elements of wind 48, namely crosswind vector 52 is the crosswind element and tailwind vector 56 is the tailwind vector which is in the negative director for headwind.

### Deep Learning Model Use and Operation

FIGS. 10A through 10F illustrates the use and operation of the AI device 10.

FIG. 10A illustrates positioning the AI device 10, flexible rod 106, and string anchor 108, and the string 40 along a projectile trajectory path to a target. The string 40 pass through a pulley 510 so the flex of the rod 106 and the target can be captured in the same field of view. The AI device should be positioned about six feet from the rod 106 with a full view of the string 40 to the anchor 108. This is the positioning step.

FIG. 10B illustrates an image 36 captured by the AI device 10. The image is displayed on a high-resolution display 31, showing the shape and position of the string 40. The image 36 also shows the flex of the flexible rod 106. The anchor point may not be visualized but would mark the end of the string 40. This is the capture step.

FIG. 10C illustrates a detection crop from the image 36 with four bounding points 37 forming a bounding rectangle containing the cropped image of the string 40 and rod 106, which is cropped from the image 36 of FIG. 10B. This is the first part of the detection step.

FIG. 10D illustrates fiducial points 38 found on the string and the rod of the cropped image of FIG. 10C. Fiducial points 38a through 38e mark the curve of the string in the cropped image. Fiducial points 38h and 38f mark the ends of the rod in the cropped image. Fiducial points 38f, 38g, and 38h mark the curve or flex of the rod. Determining the fiducial points 38 is the second part of the detection step. The tar weight of the string plus the collective force of the wind against the string pulls the rod toward the pulley. The pulley allows the image to show both the flex of the rod and the full path of the string, allowing the same camera to capture the shape and position of the string 40 and the flex of the rod 106 in the same image (e.g., FIG. 10B).

In another embodiment the AI device 10 measures the height of the portion of the rod 106 (e.g., by using the bottom of the dark bands 802a, 802b, 802c) in pixels, and determines the distance from the camera to the rod 106.

FIG. 10E illustrates fiducial points 38 defining the shape and position of the string (in this case 38a through 38e).

FIG. 10F illustrates fiducial points 38 defining the flex of a flexible rod (in this case 38f, 38g, and 38h showing the curve or flex of the rod 106).

Next in the alignment step, the cropped image scaled to a standard size. The length of the rod is used as the standard for scaling. Thus, the user can place the AI device 10 at any reasonable distance from the rod 106. This removes the need for the user to measure the placement for accuracy of the deep learning model.

DeepFace teaches that near 100% face recognition can be achieved with both 2D rotation and 3D alignment. Alignment is optional. In our preferred embodiment, 3D alignment using the fiducial points 38, as well as determined lengths and distances, is used to align the image such that the flex of the rod and the entire string 40 curve(s) are visualized in the aligned image

These comprise the alignment step. The alignment is applied by image transforming the fiducial points. After the fiducial points have been aligned, the image pixels are no longer needed,

The cropped, scaled, 2D aligned, and optionally 3D aligned fiducial points for each of a multiplicity of images 36, as well as the wind sensor information captured at the same time as the image, are given as inputs to the deep neural networks (DNN). Optionally, a concurrent sound recording is converted to a spectrogram and the spectrogram fiducial contours are given as an input to the DNN.

The DNN is trained on the wind recognition task with a goal of output a wind direction and speed in relation to the directional alignment of the bottom of the rod 106 and the target.

In simple terms, the DNN is used to classify the multiplicity of images 36 to a particular crosswind class (and optionally headwind/tailwind class). Once trained the AI device 10 can classify a single new image and/or sound, and output a particular crosswind and tailwind based on a matching class. See operation below.

In practice, a very small percentage of shots need to be taken in winds greater than 30 m.p.h. (miles per hour). Thus, the ability to identify 60 distinct classes for cross wind (e.g., 30 from left cross winds from 0 to 30 m.p.h. and 30 for right cross winds from 0 to 30 m.p.h.) should be sufficient for general hunting or target shooting applications. Our model thus is less complex, smaller, and faster than the DeepFace model.

DeepFace also teaches that the number of layers in the DNN can be varied to simplify or to enhance the error rates. Accordingly, one skilled in the arts of computer vision and machine learning, and in particular DNN-based image classification would be able to modify the DNN to meet their particular needs and parameters of their product (such as process speed, memory size, battery life, etc.).

In one embodiment of the DNN, only the string fiducial points 38 are used. In another embodiment of the DNN only the rod fiducial points 38 are used. In yet another embodiment only the rod fiducial points and the sound fiducial contours are used. To be clear, each input is labeled with sensed wind values from one or more wind sensors 860.

### Analog String Anemometer

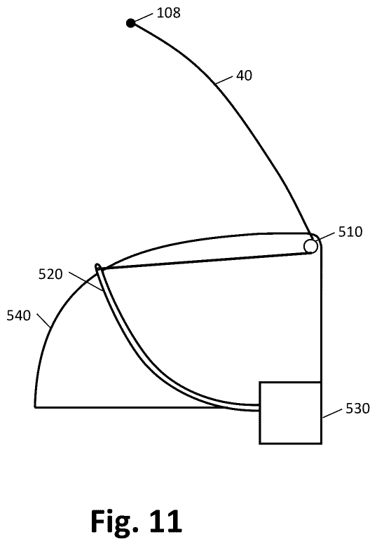

FIG. 11 shows an analog string anemometer comprising a string 40, an attached flexible rod 520, a pulley 510, and a scale 540 attached to a base 530. In this embodiment, the scale 540 comprises of a curved edge, the curve matching the path of the tip of the attached flexible rod 520. The scale optionally comprises one or more tick marks which represent wind speed at the various wind speeds. For example, there could be a 5-mile, 10-mile, 15-mile, 20-mile, etc. tick mark on the scale for a predetermined string length at 80 yards.

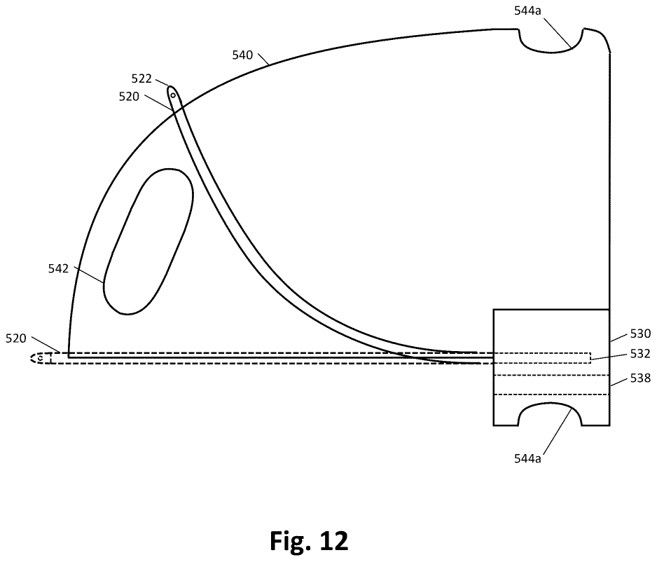

FIG. 12 shows an embodiment of an analog string anemometer further comprising a gauge handle 542 and string notches 544a-b for winding up the string 40. FIG. 12 also illustrates a gauge rod hole 532 and a bolt hole 538, both in base 530. FIG. 12 shows the resting position of the gauge rod 520 with dashed lines and the fully flexed position with solid lines.

The handles 542 is positioned such that the string 40 can easily wrapped around the scale 540, held in the string notches 544, by rotating the wrist.

In the other embodiments, the string 40 is held on a reel or spool.

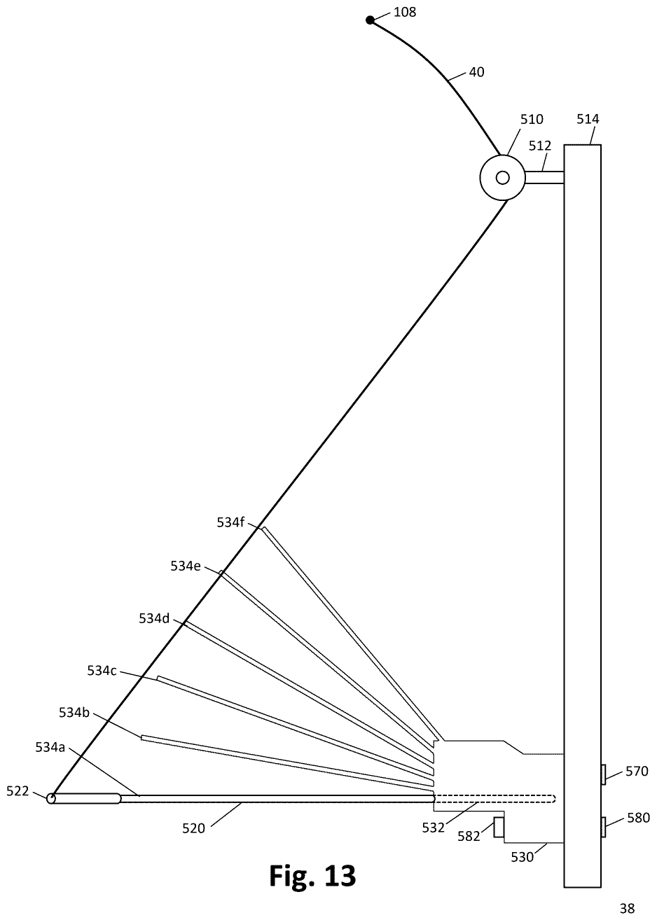

FIG. 13 shows another embodiment of an analog string anemometer comprising a string 40, an attached flexible rod 520, a pulley 510, a scale comprising scale rods 534a-f attached to a base which is further bolted, using a bolt 580, and pinned, using a pin 570, to a square tube 514 having a pulley 510 attached at the other end. In a currently preferred embodiment, base 530 is removably connected to the tube 514 using a bolt 580 and a wing-nut 582. Flexible rod 520 is connected to the base 530, using a gauge rod hole 532. Further, the string 40 is attached to the flexible rod 520 using tip connector 522. The scale rods 534a-f are removably inserted into preformed holes in the base 530. Two straps (not shown) can be attached using the analog scale bolt 580 and the pulley attachment 512. The straps can be used to attach the wind gauge to a tree or post. This embodiment can be disassembled and carried in a narrow sack.

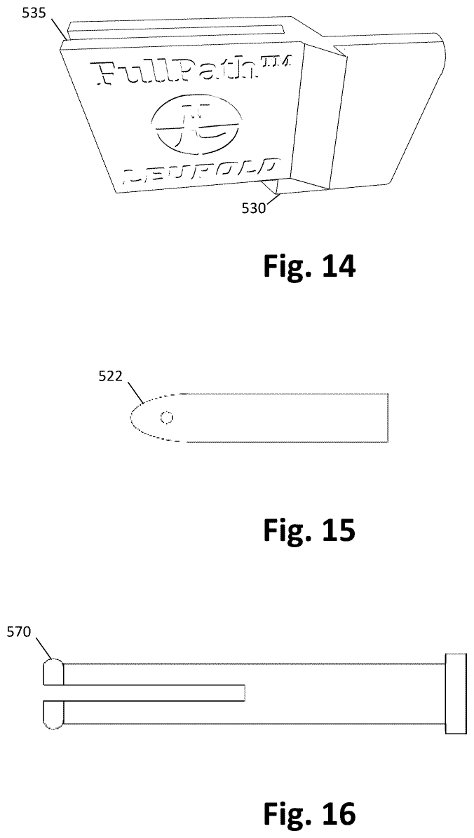

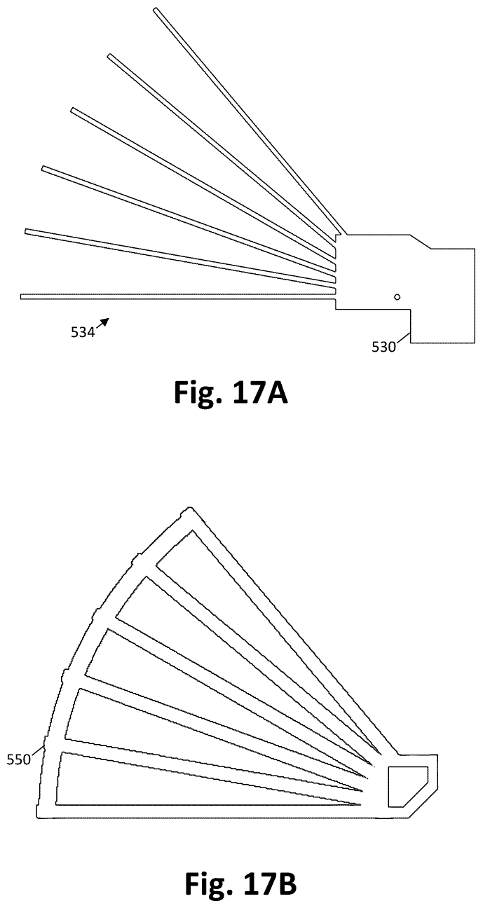

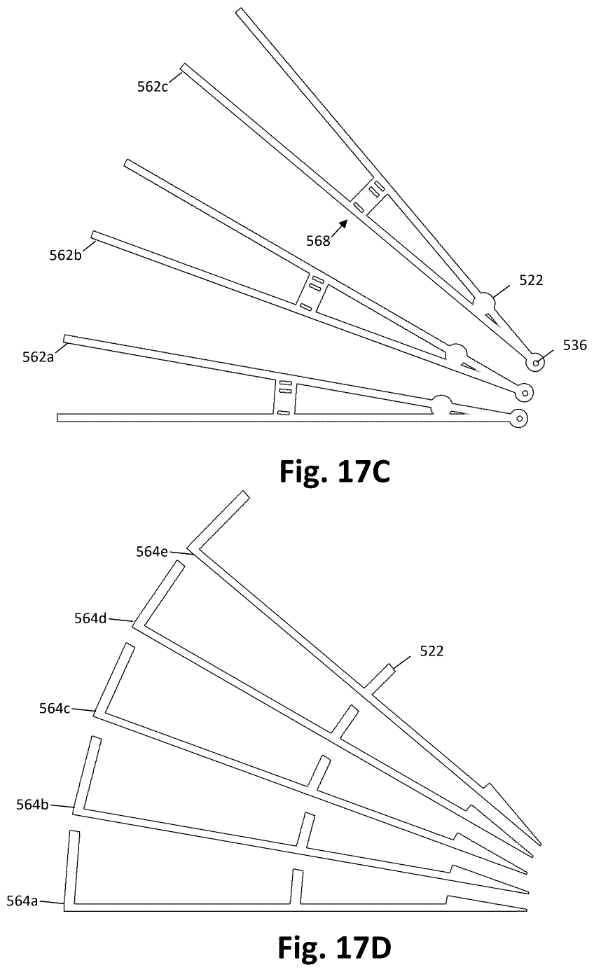

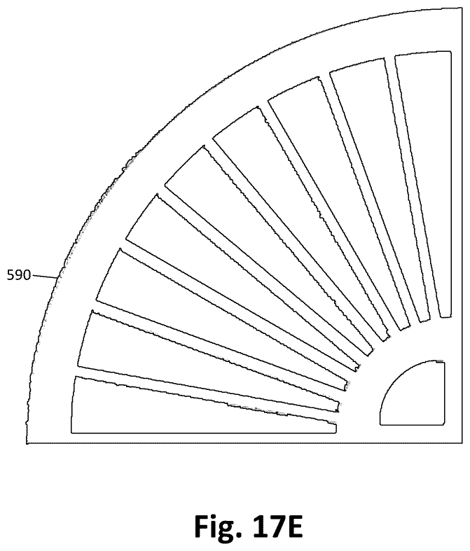

FIG. 14 illustrates features of a scale base 530 having a scale slot 535. Several embodiments of scale 530 which can be removably attached in the scale slot are discussed in regard to FIGS. 17B through 17E.

FIG. 15 illustrates a tip connector 522 having a hole for attaching to one end of the gauge rod 520 and a perpendicular hole for connecting the string 40. In a currently preferred embodiment, the gauge rod 520 is a fiberglass rod and the tip connector 522 is glued to the rod 520 using E6000 cement. The other end of the rod 520 optionally is glued to the base 530.

FIG. 16 illustrates a pin 570 for removable attaching the scale base 530 to a tube 514;

FIGS. 17A through 17E illustrate embodiments of scales 540. Preferably the scale indicators (FIG. 17B through 17E) or scale rods 534 (FIGS. 13 and 17A) are place at 10 degree intervals as shown, or at positions representing intervals of wind speeds, such as 5, 10, 15, 20, 25 miles per hour. The wind speed intervals embodiment would only be precise with a predetermine string type and length. Such an embodiment could be permanently installed at a range, for example, an 80-yard embodiment at an archery range.

FIG. 17A illustrates a scale 540 comprising a plurality of scale rods 534 removably inserted in holes in scale rod embodiment of a scale base 530, forming a packable embodiment of the wind gauge as shown in FIG. 13. For transport in the field, this embodiment is disassembled. The scale rods 534 are stored inside the tube 514 (FIG. 13). For operation, the scale rods 534 are inserted into preformed holes in the scale base 530.

FIG. 17B illustrates a scale 540 comprising a 50-degree scale 550. This embodiment shows scale indicating vanes at 10° intervals with a solid arc at the perimeter allowing the attached flexible rod 520 (not shown) to move along the scale without interference.

FIG. 17C illustrates a scale 540 comprising a plurality of fan vanes 562a-c. Each fan vane 562 is inserted in the scale slot 535 shown in FIG. 14. A vane spacer 566 aids in aligning the fan vanes 562 at the desired angle. In this embodiment, each fan van 562 comprises a vane pivot 536 and pivots around a pin in the scale base 530. The fan vanes are interconnected with a ribbon (not shown) passing through ribbon holes 568 in each fan vane 562. For transport in the field, this embodiment is disassembled by collapsing the fan formed by the fan vanes 562a-c and the ribbon.

FIG. 17D Illustrates a scale 540 comprising a plurality of single vanes 564a-f. Each single fan vane 564 is inserted in the scale slot 535. A vane spacer 566 aids in aligning each single vanes 564 at the desired angle. For transport in the field, this embodiment is disassembled and the single vanes 564 are stored inside the tube 514 (FIG. 13).

FIG. 17E illustrates a scale 540 comprising a 90-degree scale 590. This embodiment shows scale indicating vanes at 10° intervals with a solid arc at the perimeter allowing the attached flexible rod 520 (not shown) to move along the scale without interference.

### Digital String Anemometer

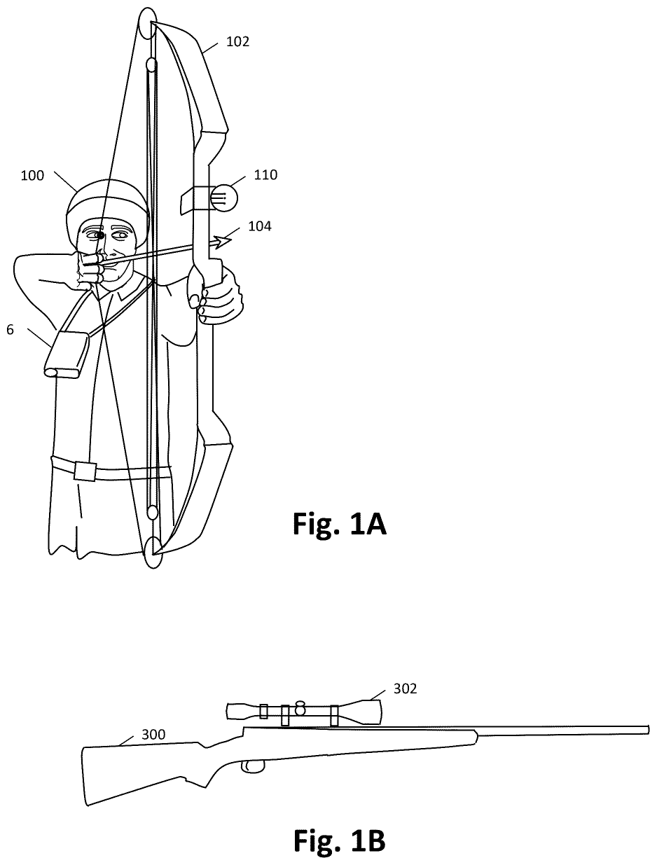

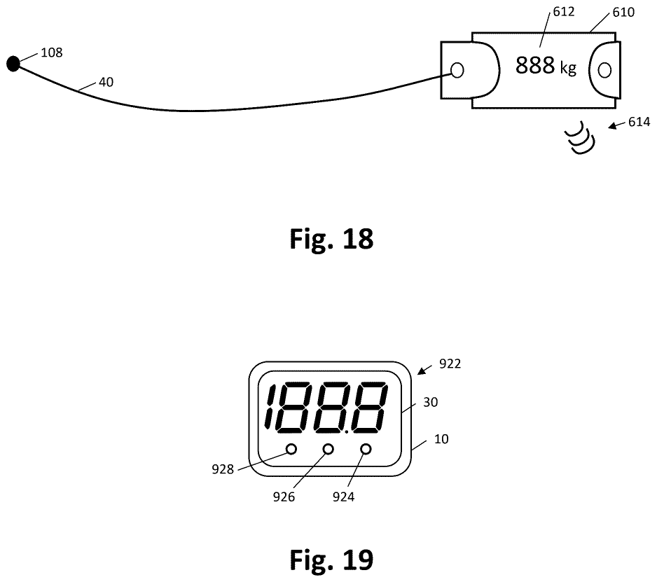

FIG. 18 illustrates a digital string anemometer comprising a string 40 connected to digital scale 610 at one end and to a string anchor 108 at the other end. The digital scale 610 measures the force of the wind upon the full path of string. The digital scale 610 comprises a display 612. Optionally digital scales 610 comprises scale wireless communication 614. In some embodiments, the digital scale 610 communicates with AI device 10 via wireless communication 614, or with a range finding device 6 (FIG. 1).

The digital scale 610 comprises a digital scale similar to Weiheng WH-C06 Bluetooth 300 kg Hanging scale.

FIG. 19 illustrates an AI device 10 integrated with digital scale 610 (internal) having a display 30 with crosswind indicator 922 and indicators of a steady state of optimum wind; green indicator 924, yellow indicator 926, and yellow indicator 928.

A system embodiment comprises the digital scale 610 integrated with an AI device 10; in this embodiment the AI device 10 does not require a camera or audio sensor as it receive wind information directly from the digital scale.

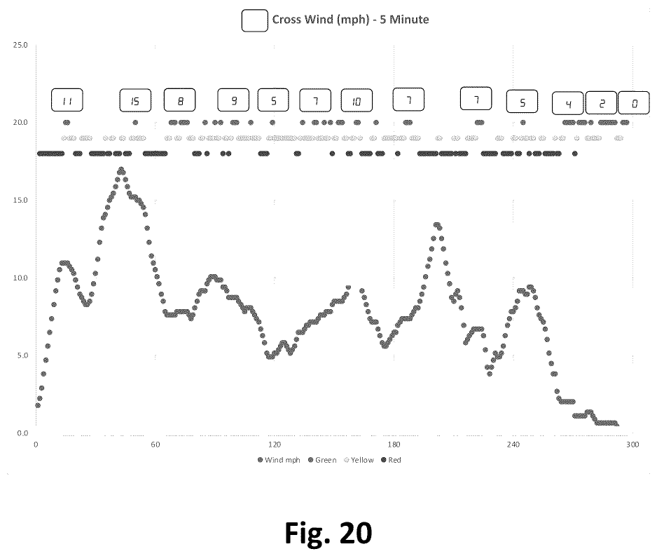

FIG. 20 is a chart showing what would be displayed on the display 30 of FIG. 19 based on exemplary crosswinds reading over a five minute period. The values in the rectangle would be displayed when the cross wind is steady. Red, yellow, and green indicators would be illuminated at points in time. The parent application provides more details regarding the determination of the displayed values and the yellow and green indicators.

### Advantages

### Accurate

The AI device provides for accurate adjustment of aim based on more accurate identification of wind speed.

### Effective

Because the AI device provides for accurate adjustment of aim for wind, each shot taken will be more effective.

### Confidence

The AI wind information gives the user confidence that wind age has been accurately identified. This increased confidence will improve the user's performance and satisfaction.

### Increased Safety

More accurate aiming increases safety.

### Packable

Some embodiments may be collapsed or disassembled for transport.

### Lightweight

Handheld or portable mounted AI devices are lightweight.

### Easy to Transport and Use

AI devices easy to transport and use.

### Rapid Use

Embodiments that provide an aiming point are used rapidly without having to use brain power to select numbers and estimate an aiming point.

### Conclusion, Ramification, and Scope

Accordingly, the reader will see that the novel string anemometer provides important information regarding the projectile trajectory path and importantly provide greater accuracy, effectiveness, and safety.

While the above descriptions contain several specifics these should not be construed as limitations on the scope of the invention, but rather as examples of some of the preferred embodiments thereof. Many other variations are possible. The high magnification digital image could be produced by a zoom lens system where the magnification is variable and passed as an input to the wind calculations. The AI device and methods could be applied to military situations where the projectiles are fired from a cannon, tank, ship, or aircraft and where the obstacles could be moving objects such as helicopters or warfighters. Additionally, the AI device and methods could be applied to golf where in a golf mode the device would provide a wind adjusted aiming point. The variations could be used without departing from the scope and spirit of the novel features of the present invention.

Accordingly, the scope of the invention should be determined not by the illustrated embodiments, but by the appended claims and their legal equivalents.

1. A string anemometer.

2. The string anemometer of claim 1, comprising a string and a scale, wherein the string detects the effect of wind along a full path of the string.

3. The string anemometer of claim 2,
wherein a length of the string is measured in tens or hundreds of yards or meters.

4. The string anemometer of claim 2,
wherein the scale is an analog scale.

5. The string anemometer of claim 4,
wherein the analog scale comprises a flexible rod.

6. The string anemometer of claim 5,
wherein the rod is a ½ inch fiberglass rod and the length of the string is between 50 yards and 1000 yards.

7. The string anemometer of claim 4,
wherein the scale comprises scale indicators positioned at 10 degree intervals.

8. The string anemometer of claim 4,
wherein the scale comprises scale indicators positioned a wind speed intervals.

9. The string anemometer of claim 5,
wherein the flexible rod and the scale is attached to a scale base.

10. The string anemometer of claim 9,
wherein the scale base further comprises a scale slot.

11. The string anemometer of claim 10,
wherein the scale slot receives one of the group of:
a) a 50 degree scale,
b) a 90-degree scale,
c) a plurality of fan vanes, and
d) a plurality of single vanes.

12. The string anemometer of claim 5, further comprising a tip connector,
wherein the tip connector is permanently attached to the flexible rod, the tip connector having a hole for attaching the string to the flexible rod.

13. The string anemometer of claim 5, further comprising a pulley,
wherein the pulley changes the viewing angle of the flexible rod.

14. The string anemometer of claim 9, further comprising a pulley attached to a tube,
wherein the scale base is removable attached to the tube, and
wherein the pulley changes the viewing angle of the flexible rod against the scale.

15. The string anemometer of claim 9,
wherein the scale base is removably attached to the tube with at least one metal bolt.

16. The string anemometer of claim 9,
wherein the scale base is removably attached to the tube with at least one removable pin.

17. The string anemometer of claim 2,
wherein the scale is a digital scale.

18. The string anemometer of claim 17,
wherein the digital scale wirelessly communicates a digital scale value.

19. A system comprising the string anemometer of claim 18 and an AI device,
wherein the digital scale communicates the digital scale value to the AI device,
wherein the AI device determines a steady state of the wind, and
wherein the AI device displays a crosswind speed.

20. A system comprising the string anemometer of claim 2 and an AI device,
wherein the AI device observes the flex of the rod,
wherein the AI device determines a steady state of the wind, and
wherein the AI device displays a crosswind speed.
